(19) United States
(12) Patent Application Publication
(10) Pub. No.: US 2025/0258726 A1
(43) Pub. Date: Aug. 14, 2025

(54) COMPUTER SYSTEM CONFIGURED TO SHARING DATA BETWEEN TWO PROCESSORS

(71) Applicant: STMicroelectronics International N.V., Geneva (CH)

(72) Inventor: Bechir JABRI, Ariana (TN)

(73) Assignee: STMicroelectronics International N.V., Geneva (CH)

(21) Appl. No.: 19/035,223

(22) Filed: Jan. 23, 2025

(30) Foreign Application Priority Data
Feb. 14, 2024 (FR) FR2401429

(51) Int. Cl. G06F 9/54; G06F 9/46

(52) U.S. Cl. CPC G06F 9/544; G06F 9/468

(57) ABSTRACT

According to one aspect, a computer system is proposed comprising: a first processor, known as sender processor, and a second processor, known as destination processor, a first memory, known as source memory, associated with the sender processor, and a second memory, known as destination memory, associated with the destination processor, the source memory being configured to store data that may be intended for the destination processor, a transmission module controlled by the sender processor and by the destination processor, the transmission module being configured to transfer a message comprising data intended for the destination processor from the source memory towards the destination memory.

### TECHNICAL FIELD

Embodiments and implementations relate to computer systems, and more particularly the communication of data between a plurality of processors of a computer system.

### DESCRIPTION OF THE RELATED ART

Some computer systems have a plurality of processors (also designated by the expression “cores” or by the expression “Central Processing Units”).

These processors can be programmed to exchange data. The data exchange between processors is also designated by the expression Inter-Processor Communication (IPC).

The data exchange between processors may be useful for various applications so that the processors can coordinate or collaborate with one another. For example, a first processor may be used to control an acquisition of data by a sensor and a second processor may be used to process the acquired data. In this case, the data acquired using the first processor are made available to the second processor so that the latter can process them.

In particular, the processors can exchange data via a shared memory. Using a shared memory enables the processors to access data stored in the same area of the shared memory. This shared memory therefore makes it possible to exchange data between the processors.

This area of the shared memory is defined during a computer program development phase implemented by the two processors. More particularly, the shared memory should be defined in linker files for the two processors. Thus, the shared memory should be agreed from the development of the computer programs implemented by two processors. Furthermore, it is also important to define from this development the size of the shared memory areas receiving the shared data.

Using a shared memory also has the drawback of involving a copy of the shared data. In particular, the sender processor copies the data from a source memory in the shared memory. The receiver processor can subsequently use then erase the data copied in the shared memory or copy them in another memory in order to receive new data in the same shared memory area.

Furthermore, the transfer of shared data is controlled directly by the sender processor and by the destination processor. Thus, the sender processor and the destination processor cannot process other tasks while they are controlling the transfer of shared data.

It is also important to prevent the sender processor from writing new data in the shared memory before the destination processor has read the preceding data. In order to synchronize, the sender processor and the destination processor then send interrupts. In particular, the sender processor is configured to generate an interrupt to inform the destination processor that new data are available in the shared memory. The destination processor is for its part configured to generate an interrupt once it has read the shared data. This management of interrupts by the processors also does not make it possible to place the processors in a low consumption mode during the data transfer.

### BRIEF SUMMARY

There is therefore a need to propose a solution for simplifying the communication of data between a plurality of processors.

According to one aspect, a computer system is proposed comprising:
a first processor, known as sender processor, and a second processor, known as destination processor,
a first memory, known as source memory, associated with the sender processor, and a second memory, known as destination memory, associated with the destination processor, said source memory being configured to store data that may be intended for the destination processor, and
a transmission module controlled by the sender processor and by the destination processor, the transmission module being configured to transfer a message comprising data intended for the destination processor from the source memory to the destination memory.

The computer system makes it possible to use a transmission module to transfer messages from a source memory, associated and defined by a sender processor, to a destination memory, associated and defined by a destination processor.

Such a computer system makes it possible to prevent use of a shared memory between two processors. Therefore, it is not necessary to define a static area to be shared of the memory for the two processors. Each processor can define its own memory area wherein the message is stored without agreeing with the other processor.

Furthermore, such a computer system has the advantage of enabling the sender processor and the destination processor to carry out other tasks from the beginning of the transfer of the message. Indeed, the transmission module takes care of the entire transfer of the message. The sender processor and the destination processor themselves therefore do not carry out the transfer of the message. The sender processor and the destination processor can also enter a low consumption mode until the end of the transfer of the message.

Advantageously, the transmission module is a direct memory access controller.

In an advantageous embodiment, the transmission module comprises a first register controlled by the sender processor and configured to authorize a transfer of said message by said transmission module.

Preferably, the transmission module comprises a second register controlled by the sender processor and configured to store a source address pointing to an area of the source memory comprising the data of the message to be transferred.

Thus, the sender processor can dynamically define its own memory area wherein the data to be transferred are stored.

In an advantageous embodiment, the transmission module comprises a third register controlled by the destination processor and configured to store a destination address pointing to an area of the destination memory intended to receive the data of said message to be transferred.

Thus, the destination processor can dynamically define its own memory area wherein the data of the message transmitted are stored.

Preferably, the transmission module comprises a fourth register controlled by the destination processor and configured to store a length of the message to be transferred.

Advantageously, the sender processor is configured to read access the fourth register and to start the transfer of the message by the transmission module once the length of the message has been defined by the destination processor in the fourth register. This makes it possible to carry out a communication between the sender processor and the destination processor by using an already existing direct memory access controller, without modifying the computer system.

Preferably, the sender processor is configured to detect that the length of the message has been defined by the destination processor when the value stored in the fourth register is different from zero.

In an advantageous embodiment, the transmission module comprises a synchronization register, the destination processor being configured to store information in the synchronization register for indicating that the destination memory is ready to receive the message, the transmission module being configured to generate an interrupt signal intended for the sender processor when the synchronization register indicates that the destination memory is ready to receive the message.

Such an interrupt signal makes it possible to simply inform the sender processor that the destination processor is ready for the transfer of the message. Furthermore, the sender processor can enter a low consumption mode or carry out other tasks while waiting to receive the interrupt signal.

Preferably, the transmission module comprises an access control register configured to define authorizations to access the registers of the transmission module for the sender processor and for the destination processor.

Advantageously, the transmission module is configured to generate a first interrupt signal intended for the destination processor when a transfer of a message intended for the destination processor is finished.

Preferably, the transmission module is configured to generate a second interrupt signal intended for the sender processor when a transfer of a message intended for the destination processor is finished.

Advantageously, the transmission module comprises a fifth register configured to store a flag indicating an end of transfer of the message, the destination processor being configured to erase this fifth register in order to acknowledge the receipt of a new message and enable the transmission module to generate new interrupt signals during a next message transfer.

In an advantageous embodiment, the transmission module is configured to decrement during the transfer the value stored in the fourth register and initialized with the length of the message, the first interrupt signal and the second interrupt signal being generated when the value stored in the fourth register reaches zero.

Advantageously, the address stored in the second register of the transmission module points to a chained list in the source memory comprising a succession of addresses pointing to various memory areas including data intended for the destination processor, the transmission module being configured to successively transmit messages comprising the data of the various memory areas pointed by said chained list.

According to another aspect, a method implemented by a computer system is proposed comprising:
a first processor, known as sender processor, and a second processor, known as destination processor;
a first memory, known as source memory, associated with the sender processor, and a second memory, known as destination memory, associated with the destination processor, said source memory being configured to store data that may be intended for the destination processor; and
a transmission module,
the method comprising:
   controlling the transmission module by the sender processor and by the destination processor in order to initialize a transfer of a message comprising data intended for the destination processor from the source memory to the destination memory; then
   transferring said message by the transmission module from the source memory to the destination memory.

### BRIEF DESCRIPTION OF THE SEVERAL VIEWS OF THE DRAWINGS

Other advantages and features of the disclosure will become apparent upon examining the detailed description of non-limiting embodiments and implementations, and from the accompanying drawings, wherein:

FIG. 1, FIG. 2, FIG. 3, FIG. 4, FIG. 5, and FIG. 6 schematically illustrate implementations and embodiments of the disclosure.

### DETAILED DESCRIPTION

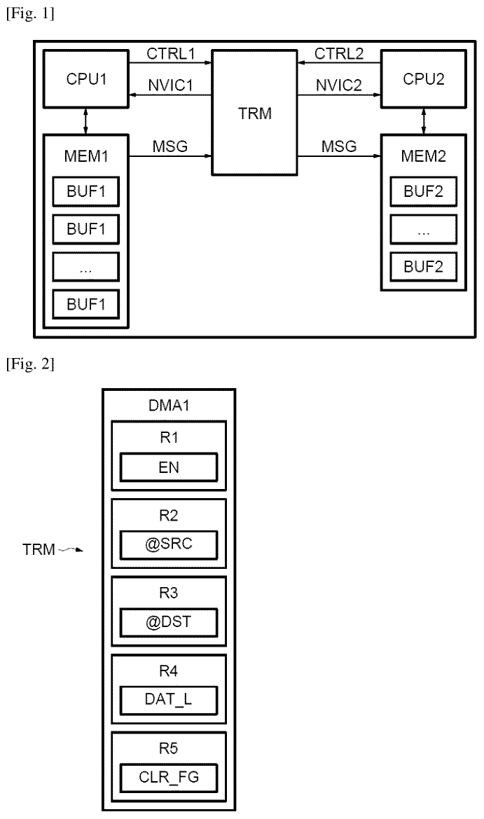

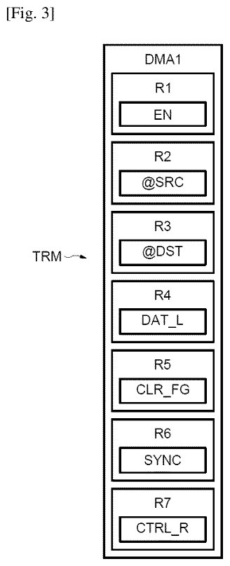

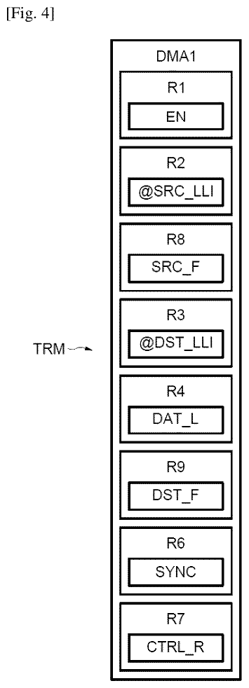

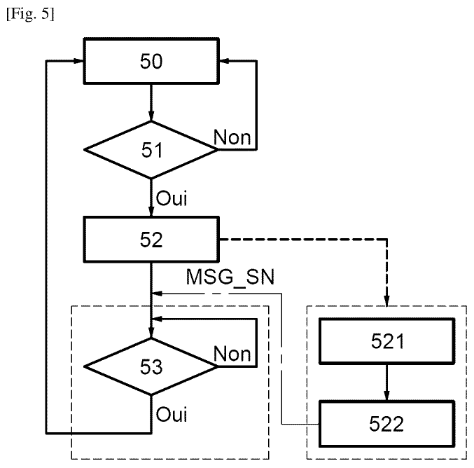

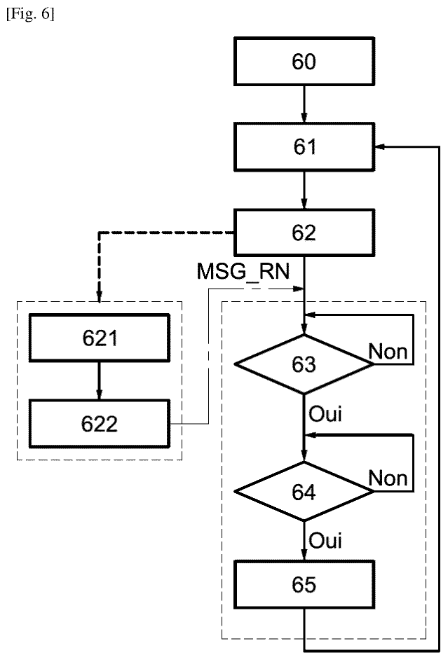

FIG. 1 illustrates an embodiment of a computer system SYS. The computer system SYS may be a microcontroller. For example, the microcontroller may have an ARM® Cortex-M architecture.

The computer system SYS comprises a sender processor CPU1.

The computer system also comprises a source memory MEM1. The source memory MEM1 may be a volatile memory, particularly a random-access memory (RAM).

The source memory MEM1 comprises a set of buffer memories BUF1. The source memory MEM1 is configured to store data for the sender processor CPU1. In particular, the source memory MEM1 is connected to the sender processor CPU1 so as to enable the sender processor CPU1 to read and write access the source memory MEM1.

The computer system SYS also comprises a destination processor CPU2.

The computer system also comprises a destination memory MEM2. The destination memory MEM2 may be a volatile memory, particularly a random-access memory.

The destination memory MEM2 comprises a set of memory areas, particularly buffer memories BUF2. The destination memory MEM2 is configured to store data for the destination processor CPU2. In particular, the destination memory MEM2 is connected to the destination processor CPU2 so as to enable the destination processor CPU2 to read and write access the destination memory MEM2.

The computer system SYS also comprises a transmission module TRM. The transmission module TRM may be a direct memory access (DMA) controller. In an alternative embodiment, the transmission module TRM may be a “mailbox” type circuit in an ARM® architecture when this circuit is configured to be able to carry out a data transfer between the source memory MEM1 and the destination memory MEM2.

The transmission module TRM is shared between the sender processor CPU1 and the destination processor CPU2. In particular, the transmission module TRM is configured to transmit data intended for the destination processor and stored in the source memory MEM1 to the destination memory MEM2. These data are transmitted in at least one message MSG.

The transmission module TRM is connected to the source memory MEM1 so as to be able to read access the source memory MEM1. This makes it possible for the transmission module TRM to receive the data stored in the source memory MEM1 to be transmitted to the destination memory MEM2.

The transmission module TRM is also connected to the destination memory MEM2 so as to be able to write access this destination memory MEM2. This makes it possible for the transmission module TRM to write in the destination memory MEM2 the data received from the source memory MEM1.

The transmission module TRM is controlled by the sender processor CPU1 or by the destination processor CPU2. In particular, the sender processor CPU1 is connected to the controller DMA1 in order to communicate to it control data CTRL1 for controlling certain registers of the transmission module TRM. The destination processor CPU2 is connected to the controller DMA1 in order to communicate to it control data CTRL2 for controlling other registers of the transmission module TRM.

It is also possible to define a security attribute for completing the isolation of the two processors CPU1 and CPU2. The security attribute is then used to define access rights of the processors CPU1 and CPU2 to the source memory MEM1 and to the destination memory MEM2. For example, the security attribute may enable access to the source memory MEM1 only for the sender processor CPU1, and enable access to the destination memory CPU2 only for the destination processor CPU2. This makes it possible to isolate the two processors CPU1 and CPU2 so as to better protect the data stored in the source memory MEM1 and in the destination memory MEM2.

The computer system SYS makes it possible to use a transmission module TRM to transfer messages MSG from the source memory MEM1, associated and defined by the sender processor CPU1, to the destination memory MEM2, associated and defined by the destination processor CPU2. Such a computer system SYS makes it possible to prevent use of a shared memory between two processors. Therefore, it is not necessary for the two processors to agree on an area to be shared in the memory. Each processor may define its own memory area wherein the message MSG is stored.

Furthermore, such a computer system SYS has the advantage of enabling the sender processor CPU1 and the destination processor CPU2 to carry out other tasks from the beginning of the transfer of the message MSG. Indeed, the transmission module TRM takes care of the entire transfer of the message MSG. The sender processor CPU1 and the destination processor CPU2 themselves therefore do not carry out the transfer of the message MSG. The sender processor CPU1 and the destination processor CPU2 can also enter a low consumption mode until the end of the transfer of the message MSG.

In addition, it is not necessary to copy the messages MSG in order to carry out their transfer. FIG. 2 illustrates a first embodiment of a transmission module TRM. Here, the transmission module TRM is a direct access memory controller DMA1.

More particularly, the controller DMA1 comprises a first register R1 controlled by the sender processor CPU1 to activate the transfer of the message MSG by the controller DMA1 when the destination processor CPU2 is ready to receive the message MSG.

The controller DMA1 also comprises a second register R2 configured to store a source address @SRC of the source memory MEM1. The source address @SRC points to the memory area of the source memory MEM1 comprising the data to be transferred. This second register R2 is also controlled by the sender processor CPU1. The sender processor CPU1 is configured to be able to define a different source address @SRC for each message MSG.

The controller DMA1 also comprises a third register R3 configured to store a destination address @DST of the destination memory MEM2. The destination address @DST points to the memory area of the destination memory MEM2 intended to receive the data coming from the source memory MEM1. This third register R3 is controlled by the destination processor CPU2. The destination processor CPU2 is configured to define a destination address @DST for each message MSG to be received.

The controller DMA1 further comprises a fourth register R4 configured to define a length DAT_L of the message MSG to be transmitted. This length of the message makes it possible to indicate the length DAT_L of the message MSG that the destination memory MEM2 can receive. This length of the message corresponds particularly to the area of the destination memory MEM2 allocated for storing the data of the message MSG. This fourth register R4 is controlled by the destination processor CPU2. The sender processor CPU1 is configured to read the content of this fourth register R4 in order to know the length of the message MSG to be used. Furthermore, the sender processor CPU1 is configured to determine that the destination processor CPU2 is ready to receive a message MSG when the value in this fourth register R4 is different from zero. The value of the fourth register R4 is configured to be decremented by the controller DMA1 during the transfer of a message MSG until it reaches zero at the end of the transfer.

The length DAT_L of the message MSG may be adjusted at the request of the processor CPU1. In particular, the destination processor is configured to define an initial message length. Subsequently, the sender processor CPU1 is configured to send a message requesting the destination processor CPU2 to adjust the length DAT_L of the message MSG. The destination processor CPU2 is then configured to allocate an area of the memory corresponding to the message MSG length DAT_L requested by the sender processor CPU1. Subsequently, the destination processor CPU2 is configured to update the destination address @DST in the register R3 as well as the length DAT_L of the message MSG in the register R4. The sender processor CPU1 is configured to subsequently verify the value of the length DAT_L of the message MSG stored in the register R4 before authorizing the transfer of the message MSG.

Such a controller DMA1 thus has the advantage of making it possible to adjust the length of messages MSG.

The controller DMA1 further comprises a fifth register R5 configured to store a flag CLR_FG. The destination processor CPU2 is configured to erase this register R5 in order to acknowledge the receipt of a new message and enable the transmission module TRM to generate signals for interrupting a message transfer.

In particular, an interrupt signal is transmitted to the sender processor CPU1 via the connection NVIC1 when a message MSG is transmitted to the destination processor CPU2. Furthermore, an interrupt signal is transmitted to the destination processor CPU2 via the connection NVIC2 when a message MSG is received by the controller DMA1 from the sender processor CPU1.

FIG. 3 illustrates a second embodiment of a transmission module TRM, also corresponding to a direct memory access controller DMA2.

The direct memory access controller DMA2 comprises the same registers R1, R2, R3, R4 and R5 as the direct memory access controller DMA1 described previously in relation to FIG. 2.

The direct memory access controller DMA2 also comprises a synchronization register R6. This register R6 makes it possible to indicate when the destination processor CPU2 is ready. The destination processor CPU2 is configured to define a control bit in this register R6 in order to indicate that it is ready to receive. In particular, this register is configured to generate an interrupt signal when the destination processor CPU2 indicates that it is ready to receive the message MSG.

In this case, the sender processor CPU1 no longer needs to probe the value of the register R4 intended to contain the length of the message MSG. Thus, it is possible to modify a power supply mode of the sender processor CPU1 in order to reduce its consumption of the sender processor CPU1 by waiting for the destination processor CPU2 to be ready to receive a message MSG.

The controller DMA2 also comprises an access control register R7. The access control register makes it possible to isolate the registers so such that the registers R1 and R2 can be accessed only by the sender processor CPU1 and that the registers R3, R4, R5 and R6 can be accessed only by the destination processor CPU2.

This makes it possible to obtain a high isolation between the sender processor CPU1 and the destination processor CPU2. Indeed, each processor only has access to the registers that it can control. Furthermore, each processor only has access to the memory that is associated with it.

FIG. 4 illustrates a third embodiment of a transmission module TRM, here corresponding to a direct memory access controller DMA3. The registers R1, R2, R3, R4, R6 and R7 of the controller DM3 are similar to those described previously. Nevertheless, in this embodiment, the registers R2 and R3 of the access memory controller DMA3 are configured to support chained lists.

In particular, the sender processor CPU1 is configured to define in the register R2 a chained list of memory areas of the source memory MEM1 containing various messages MSG to be transmitted. More particularly, the register R2 comprises the address of the source memory MEM1 containing the chained list of these memory areas of the source memory MEM1.

The destination processor CPU2 is configured to define in the register R3 a chained list of memory areas of the destination memory MEM2 intended to receive the various messages MSG. More particularly, the register R3 comprises the address of the destination memory MEM2 containing the chained list of these memory areas of the destination memory MEM2.

In order to synchronize the chained lists, the reloading of the chained lists is only performed when the sender processor CPU1 and the destination processor CPU2 are ready, that is to say once the transfer of a preceding message MSG is finished.

The controller DMA2 also comprises a register R8 controlled by the sender processor CPU1 and a register R9 controlled by the destination processor CPU2. These registers R8 and R9 respectively comprise control values SRC_F and DEST_F, instead of a single register R5 storing the flag CLR_FG in the embodiment of FIG. 2. These two registers R8 and R9 make it possible to restrict the access of each register to a single processor. In this way, each processor controls a respective control value independently of the other processor.

The sender processor CPU1 is configured to receive an interrupt signal indicating to it that the receiver processor CPU2 is ready to receive the message MSG. Once the sender processor CPU1 has received this interrupt signal, the sender processor CPU1 is configured to read the length of the message DAT_L indicated by the destination processor CPU1 in the register R4. In this way, the sender processor CPU1 no longer needs to regularly probe the register R4 in order to know when the destination processor CPU2 is ready to receive the message MSG.

FIG. 5 illustrates an example of method implemented by the sender processor CPU1 to transmit a message MSG intended for the destination processor CPU2 by means of the controller DMA1 described in FIG. 2. In particular, the sender processor CPU1 is configured to execute a computer program comprising instructions, which when they are executed by the sender processor CPU1, lead it to implement such a method.

The method comprises a step 50 wherein the sender processor CPU1 reads the value of the fourth register R4 intended for storing the length of the message MSG.

The method comprises a test step 51 wherein the sender processor CPU1 determines whether the length of the message MSG has been defined by the processor CPU2. In particular, the sender processor CPU1 compares the read value of the fourth register R4 with zero. If the read value of the fourth register R4 is equal to zero, this means that the destination processor CPU2 has not yet defined the length of the message MSG and that the destination processor CPU2 is not yet ready to receive the message MSG. If the read value of the fourth register R4 is different from zero, this means that the destination processor CPU2 has defined the length of the message MSG and that the destination processor CPU2 is ready to receive the message MSG.

If the read value of the fourth register R4 is equal to zero, then the method resumes at step 50 so that the sender processor CPU1 continues to probe the value of the fourth register until the length of the message MSG is defined.

If the value of the fourth register R4 is different from zero, then the method continues with a step 52. In this step 52, the sender processor CPU1 activates the transfer of the message MSG by the controller DMA1. For this purpose, the processor CPU1 activates the connection NVIC1 and indicates the source address in the second register of the controller DMA1 then modifies the first register of the controller DMA1 to activate the transfer of the message MSG. The controller DMA1 may subsequently retrieve the message to be transmitted in the source memory MEM1 from the source address in order to copy it in the destination memory MEM2 at a destination address defined by the destination processor CPU2.

Once the message MSG has been transmitted to the destination memory CPU2 by the controller DMA1, the controller DMA generates an interrupt signal for signaling the end of the transmission of the message MSG to the sender processor CPU1 and to the destination processor CPU2.

The method also comprises a step 521 that after receiving the interrupt signal at the end of transmission of the message MSG deactivates the connection NVIC1 used by the controller DMA1.

The methods subsequently comprises a step 522 wherein the sender processor CPU1 generates a notification MSG_SN in order to signal to the application program executed by the processor CPU1 that the message is sent.

Subsequently, the method comprises a test step 53 wherein, the sender processor CPU1 determines whether the notification MSG_SN has been received by the application program. If the sender processor CPU1 has not received the notification MSG_SN, then the test step is reiterated.

If the sender processor CPU1 has received the interrupt signal, then this means that the message MSG has indeed been transferred to the destination processor CPU2. Thus, the method may subsequently resume at step 50 in order to transmit a new message MSG to the destination processor CPU2.

FIG. 6 illustrates an example of method implemented by the destination processor CPU2 to receive a message MSG in the destination memory MEM2 from the sender processor CPU1 by means of the controller DMA1 described in relation to FIG. 2. In particular, the destination processor CPU2 is configured to execute a computer program comprising instructions, which when they are executed by the destination processor CPU2, lead it to implement such a method.

The method comprises a step 60 wherein the destination processor CPU2 initializes the controller DMA1 by activating a clock of the controller DMA1, by configuring it so that it can carry out a message MSG transfer from the source memory MEM1 to the destination memory MEM2 and so that it can generate an interrupt signal at the end of each message transfer by means of the connection NVIC2.

The method subsequently comprises a step 61 wherein the destination processor CPU2 defines the destination address @DST of the message MSG in the third register.

The method subsequently comprises a step 62 wherein the destination processor CPU2 erases the fifth register used for the interrupt signal. The destination processor CPU2 also defines the maximum length of the message MSG. The destination processor CPU2 activates the connection NVIC2 for the controller DMA1 so that the destination processor CPU2 can receive an end of transfer interrupt signal.

Subsequently, the method comprises a test step 63 wherein the destination processor CPU2 determines whether the message MSG has been received by the destination memory MEM2.

In particular, after step 62, the method comprises a step 621 wherein the destination processor CPU2, after having received the interrupt signal at the end of transmission of the message MSG, deactivates the connection NVIC2 of the controller DMA1. Subsequently, in step 622, the destination processor CPU2 sends a notification MSG_RN to the application program that it executes in order to inform it that the message MSG has indeed been received by the destination memory MEM2.

If, in step 63, the destination processor CPU2 has not received the interrupt signal, then this means that the message MSG has not been received. In this case, the test step 63 is reiterated. If, in step 63, the destination processor CPU2 has received the interrupt signal, then this means that the message MSG has indeed been received. In such a case, the method subsequently comprises a step 64.

In this step 64 the destination processor CPU2 determines whether the next memory area of the memory MEM2 is ready to receive a new message MSG.

If the next memory area is not ready to receive a message MSG, then step 64 is reiterated. If the next memory area is ready to receive a message MSG, then the method comprises a step 65 wherein the destination processor changes the memory area intended to receive a new message MSG. This new memory area intended to receive a new message MSG corresponds to the next memory area. Subsequently, the method resumes at step 61 in order to receive a new message MSG.

Of course, the present disclosure is open to various alternative embodiments and modifications that will become apparent to the person skilled in the art. For example, the computer system may comprise a plurality of destination processors and a plurality of destination memories. In this case, the transmission module comprises additional registers for each additional destination processor, particularly to indicate the memory areas of the destination memories. In particular, the transmission module comprises a plurality of communication channels (particularly “DMA” channels) to communicate with the various destination processors. Each channel is then a copy of the direct memory access controller that enables a communication between two processors of the computer system, in the same way as that described previously with FIGS. 1 to 6.

A computer system can include: a first processor, known as sender processor (CPU1), and a second processor, known as destination processor (CPU2), a first memory, known as source memory (MEM1), associated with the sender processor (CPU1), and a second memory, known as destination memory (MEM2), associated with the destination processor, said source memory being configured to store data that may be intended for the destination processor, a transmission module (TRM) controlled by the sender processor (CPU1) and by the destination processor (CPU2), the transmission module (TRM) being configured to transfer a message (MSG) including data intended for the destination processor from the source memory (MEM1) towards the destination memory (MEM2).

The transmission module (TRM) can be a direct memory access controller.

The transmission module (TRM) can include a first register (R1) controlled by the sender processor and configured to authorize a transfer of said message by said transmission module.

The transmission module (TRM) can include a second register (R2) controlled by the sender processor and configured to store a source address pointing to an area of the source memory including the data of the message to be transferred.

The transmission module (TRM) can include a third register (R3) controlled by the destination processor and configured to store a destination address pointing to an area of the destination memory intended to receive the data of said message to be transferred.

The transmission module (TRM) can include a fourth register (R4) controlled by the destination processor and configured to store a length (DAT_L) of the message to be transferred.

The sender processor can be configured to read access the fourth register and to start the transfer of the message by the transmission module (TRM) once the length of the message has been defined by the destination processor in the fourth register.

The sender processor can be configured to detect that the length of the message has been defined by the destination processor when the value stored in the fourth register is different from zero.

The transmission module (TRM) can include a synchronization register (R6), the destination processor being configured to store information in the synchronization register (R6) for indicating that the destination memory (MEM2) is ready to receive the message, the transmission module (TRM) being configured to generate an interrupt signal intended for the sender processor (CPU1) when the synchronization register indicates that the destination memory (MEM2) is ready to receive the message.

The transmission module (TRM) can include an access control register (R7) configured to define authorizations to access the registers of the transmission module (TRM) for the sender processor (CPU1) and for the destination processor (CPU2).

The transmission module can be configured to generate a first interrupt signal intended for the destination processor when a transfer of a message intended for the destination processor is finished.

The transmission module can be configured to generate a second interrupt signal intended for the sender processor when a transfer of a message intended for the destination processor is finished.

The transmission module (TRM) can include a fifth register (R5) configured to store a flag (CLR_FG) indicating an end of transfer of the message, the destination processor (CPU2) being configured to erase this fifth register (R5) in order to acknowledge the receipt of a new message and enable the transmission module (TRM) to generate interrupt signals during a next message transfer.

The transmission module (TRM) can be configured to decrement during the transfer the value stored in the fourth register (R4) and initialized with the length of the message (DAT_L), the first interrupt signal and the second interrupt signal being generated when the value stored in the fourth register (R4) reaches zero.

The address stored in the second register (R2) of the transmission module (TRM) can point to a chained list in the source memory (MEM1) including a succession of addresses pointing to various memory areas of the source memory (MEM1) including data intended for the destination processor (CPU2), the transmission module (TRM) being configured to successively transmit messages including the data of the various memory areas pointed to by said chained list.

Method implemented by a computer system (SYS) that includes: a first processor, known as sender processor (CPU1), and a second processor, known as destination processor (CPU2), a first memory, known as source memory (MEM1), associated with the sender processor (CPU1), and a second memory, known as destination memory (MEM2), associated with the destination processor, said source memory being configured to store data that may be intended for the destination processor, a transmission module (TRM), the method including: controlling the transmission module (TRM) by the sender processor (CPU1) and by the destination processor (CPU2) in order to initialize a transfer of a message including data intended for the destination processor (CPU2) from the source memory (MEM1) to the destination memory (MEM2), then a transfer of said message (MSG) by the transmission module (TRM) from the source memory (MEM1) to the destination memory (MEM2).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer system, comprising:
a sender processor, and a destination processor;
a source memory, associated with the sender processor, and a destination memory, associated with the destination processor, the source memory being configured to store data that may be intended for the destination processor; and
a transmission module controlled by the sender processor and by the destination processor, the transmission module being configured to transfer a message comprising data intended for the destination processor from the source memory towards the destination memory.

2. The system according to claim 1, wherein the transmission module is a direct memory access controller.

3. The system according to claim 1, wherein the transmission module comprises a first register controlled by the sender processor and configured to authorize a transfer of the message by the transmission module.

4. The system according to claim 3, wherein the transmission module comprises a second register controlled by the sender processor and configured to store a source address pointing to an area of the source memory comprising the data of the message to be transferred.

5. The system according to claim 4, wherein the transmission module comprises a third register controlled by the destination processor and configured to store a destination address pointing to an area of the destination memory intended to receive the data of the message to be transferred.

6. The system according to claim 5, wherein the transmission module comprises a fourth register controlled by the destination processor and configured to store a length of the message to be transferred.

7. The system according to claim 6, wherein the sender processor is configured to read access the fourth register and to start the transfer of the message by the transmission module once the length of the message has been defined by the destination processor in the fourth register.

8. The system according to claim 6, wherein the sender processor is configured to detect that the length of the message has been defined by the destination processor when the value stored in the fourth register is different from zero.

9. The system according to claim 1, wherein the transmission module comprises a synchronization register, the destination processor being configured to store information in the synchronization register for indicating that the destination memory is ready to receive the message, the transmission module being configured to generate an interrupt signal intended for the sender processor when the synchronization register indicates that the destination memory is ready to receive the message.

10. The system according to claim 1, wherein the transmission module comprises an access control register configured to define authorizations to access the registers of the transmission module for the sender processor and for the destination processor.

11. The system according to claim 1, wherein the transmission module is configured to generate a first interrupt signal intended for the destination processor when a transfer of a message intended for the destination processor is finished.

12. The system according to claim 11, wherein the transmission module is configured to generate a second interrupt signal intended for the sender processor when a transfer of a message intended for the destination processor is finished.

13. The system according to claim 1, wherein the transmission module comprises a fifth register configured to store a flag indicating an end of transfer of the message, the destination processor being configured to erase this fifth register in order to acknowledge the receipt of a new message and enable the transmission module to generate interrupt signals during a next message transfer.

14. The system according to claim 6, wherein the transmission module is configured to decrement during the transfer the value stored in the fourth register and initialized with the length of the message, the first interrupt signal and the second interrupt signal being generated when the value stored in the fourth register reaches zero.

15. The system according to claim 4, wherein the address stored in the second register of the transmission module points to a chained list in the source memory comprising a succession of addresses pointing to various memory areas of the source memory including data intended for the destination processor, the transmission module being configured to successively transmit messages comprising the data of the various memory areas pointed to by the chained list.

16. A method implemented by a computer system that comprises:
a sender processor, and a destination processor;
a source memory, associated with the sender processor, and a destination memory, associated with the destination processor, the source memory being configured to store data that may be intended for the destination processor; and
a transmission module,
the method comprising:
controlling the transmission module by the sender processor and by the destination processor in order to initialize a transfer of a message comprising data intended for the destination processor from the source memory to the destination memory; and
transferring the message by the transmission module from the source memory to the destination memory.

17. The method according to claim 16, wherein the transmission module comprises a first register controlled by the sender processor and configured to authorize a transfer of the message by the transmission module.

18. The method according to claim 17, wherein the transmission module comprises a second register controlled by the sender processor and configured to store a source address pointing to an area of the source memory comprising the data of the message to be transferred.

19. The method according to claim 18, wherein the transmission module comprises a third register controlled by the destination processor and configured to store a destination address pointing to an area of the destination memory intended to receive the data of the message to be transferred.

20. The method according to claim 19, wherein the transmission module comprises a fourth register controlled by the destination processor and configured to store a length of the message to be transferred.
